(19) United States
(12) Patent Application Publication
(10) Pub. No.: US 2026/0155777 A1
(43) Pub. Date: Jun. 4, 2026

(54) COUNTERBALANCE ASSEMBLIES IN PHOTOVOLTAIC SOLAR TRACKERS

(71) Applicant: ARRAY TECH, INC., Albuquerque, NM (US)

(72) Inventors: Kevin Krautbauer, Phoenix, AZ (US); Rohit Kulkarni, Chandler, AZ (US)

(21) Appl. No.: 19/406,216

(22) Filed: Dec. 2, 2025

Related U.S. Application Data
(60) Provisional application No. 63/727,919, filed on Dec. 4, 2024.

(51) Int. Cl. H02S 20/32; F16D 43/20

(52) U.S. Cl. CPC H02S 20/32; F16D 43/20

(57) ABSTRACT

A counterbalance assembly in a photovoltaic (PV) tracking system may include a top bracket, a bottom bracket, and a stretchable member. The top bracket may include a first connection point, and the top bracket may be configured to be secured to a torque tube such that the top bracket rotates with the torque tube about an axis of rotation. The bottom bracket may include a second connection point, and the bottom bracket may be configured to be secured to a column supporting the torque tube. The stretchable member may include a top end connected to the top bracket at the first connection point, a bottom end connected to the bottom bracket at the second connection point, and an unstretched length that may be different than a distance between the first connection point and the second connection point at zero degrees of torque tube rotation.

### CROSS-REFERENCE TO RELATED APPLICATIONS

This patent application claims priority to and the benefit of U.S. Provisional Patent Application Ser. No. 63/727,919, entitled COUNTERBALANCE ASSEMBLIES IN PHOTOVOLTAIC SOLAR TRACKERS, filed Dec. 4, 2024, which is incorporated by reference in its entirety.

### FIELD

The present disclosure relates to solar energy production and more particularly to counterbalance assemblies for providing adjustable tilt control of solar modules.

### BACKGROUND

Solar installations including solar farms, photovoltaic (PV) plants, solar tracking systems, fixed solar systems, and other PV systems often include large numbers of PV modules that collect sunlight and generate energy. In solar tracking systems, PV modules are supported by lateral support structures, or torque tubes, which rotate so that the PV modules may be oriented at various tilt angles to follow a position of the Sun as it moves throughout the day. The torque tubes may also rotate the PV modules to a stow angle, which may help minimize damage during weather events like hailstorms by orienting the PV modules closer to vertical.

As the torque tube rotates from a starting position (e.g., equilibrium, balance, zero degrees of torque tube rotation, or zero degrees of tilt angle), the overhanging weight of the PV modules creates a rotational torque on the torque tube. Counterbalance assemblies with springs may be utilized to produce a force that counteracts the rotational torque created by the weight of the overhanging PV modules. The counteracting force produced by counterbalance assemblies may decrease an amount of work required to be performed by a drive system (e.g., a motor) in a tracking system. The counteracting force increases as the springs are tensioned and the PV modules rotate towards a maximum tilt angle for the system.

However, these counterbalance assemblies may not provide an impactful counteracting force at low tilt angles. At low-tilt angles, the force applied by the counterbalance assembly is essentially in line or parallel to the lever arm extending from the axis of rotation. As a result, the counteracting moment is negligible.

Accordingly, there is a need for a counterbalance assembly that provides a larger counteracting force at low tilt angles allowing the PV module to rotate back to the starting position in a smoother, more controlled fashion.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Exemplary embodiments of the present disclosure address problems experienced in solar tracking systems, including problems associated with controlling the movement of PV modules at low tilt angles to bring the PV module back to a starting position (e.g., equilibrium, balance, zero degrees of torque tube rotation, or zero degrees of tilt angle). Embodiments disclosed herein address these issues by providing a counterbalance assembly including a stretchable member with a pre-loaded amount of force that increases the restorative force at low tilt angles, thereby improving tilt control of the PV module.

The counterbalance assembly may include a top bracket which is configured to be secured to a torque tube such that the top bracket rotates with the torque tube about an axis of rotation. The top bracket may include a first connection point. The counterbalance assembly may also include a bottom bracket configured to be secured to a column (or pile) supporting the torque tube. The bottom bracket may include a second connection point. The counterbalance assembly may further include a stretchable member with a top end connected to the top bracket at the first connection point and the bottom end connected to the bottom bracket at the second connection point. The unstretched length of the stretchable member may be different than a distance between the first and second connection points at zero degrees of torque tube rotation such that the stretchable member may be stretched to attach the top end to the top bracket at the first connection point and the bottom end to the bottom bracket at the second connection point. As a result, a force may be preloaded in the stretchable member to increase the restorative force of the counterbalance assembly at low tilt angles.

In some embodiments, the unstretched length is between about 50 millimeters and 1000 millimeters shorter than the distance between the first and second connection points. In some embodiments, the unstretched length is between about 100 millimeters and about 800 millimeters shorter than the distance between the first and second connection points. In some embodiments, the unstretched length is between about 200 millimeters and about 500 millimeters shorter than the first and second connection points.

In some embodiments, the stretchable member is a spring. In these embodiments, the stretchable member may be compression spring, a tension spring, a linear spring, or a variable-rate spring.

In some embodiments, the spring may include one or more drawbars. In these and other embodiments, the spring may include a first drawbar at least partially disposed within a coiled portion of the spring, and the first drawbar may be coupled to the top bracket at the first connection point. In some embodiments, a first portion of the first drawbar may be wider than the coiled portion of the spring, and the first portion may be positioned outside of the coiled portion of the spring toward the top bracket.

In these and other embodiments, the spring may include a second drawbar at least partially disposed within a coiled portion of the spring, and the second drawbar may be coupled to the bottom bracket at the second connection point.

In some embodiments, at least one of the first drawbar or the second drawbar may include one or more hooks, and each hook may contact an end of the coiled portion of the spring. In these and other embodiments, the first drawbar may include a first hook that contacts a first end of the coiled portion, and the second drawbar may include a second hook that contacts a second end of the coiled portion. In these and other embodiments, the first and second ends of the coiled portion may be opposite one another.

In these and other embodiments, a spacer may be positioned between the first drawbar and the second drawbar.

In some embodiments, the stretchable member may be pre-stretched to the distance between the first and second connection points before the top end of the stretchable member is connected to the top bracket at the first connection point and the bottom end of the stretchable member is connected to the bottom bracket at the second connection point. In some embodiments, the stretchable member may be held in a pre-stretched position by a pin. In some embodiments, the pin may be removable.

Thus, the embodiments disclosed may improve solar panel tracking systems by increasing tilt control at low tilt angles through pre-loading the stretchable member included in the counterbalance assembly. As a result, the PV modules may return to the starting position in a smoother, more controlled fashion, and the rate at which the counterbalance force increases at higher tilt angles may be reduced.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 illustrates an example photovoltaic system utilizing a counterbalance assembly;

FIG. 2A illustrates a front-view of an example counterbalance assembly including a stretchable member that is unstretched and not connected to a bottom bracket;

FIG. 2B illustrates a front-view of the example counterbalance assembly of FIG. 2A where the stretchable member is stretched and connected to the bottom bracket;

FIG. 2C illustrates an exploded view of the example counterbalance assembly of FIG. 2A;

FIGS. 2D-2E illustrate the example counterbalance assembly of FIG. 2A at varying tilt angles;

FIG. 3 is a chart showing the effect that a counterbalance assembly including a stretchable member that is not preloaded has on a restorative force;

FIG. 4 is a chart showing the effect that the counterbalance assembly of FIG. 2A may have on a restorative force applied by the stretchable member;

FIGS. 5A-5B illustrate another example counterbalance assembly at varying tilt angles;

FIG. 5C illustrates a side view of the example counterbalance assembly of FIGS. 5A-5B;

FIG. 5D is an exploded view of a stretchable member of the counterbalance assembly of FIGS. 5A-5C;

FIG. 6A is a partial view of a counterbalance assembly illustrating a stretchable member coupled to a top bracket;

FIG. 6B is another partial view of the counterbalance assembly of FIG. 6A illustrating the stretchable member coupled to the bottom bracket;

FIG. 6C is an exploded view of the stretchable member of FIGS. 6A and 6B with spacers; and

FIG. 6D illustrates a spacer used in the stretchable member of FIGS. 6A-6C.

All in accordance with one or more embodiments in the present disclosure.

### DETAILED DESCRIPTION

Embodiments of the present disclosure are explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

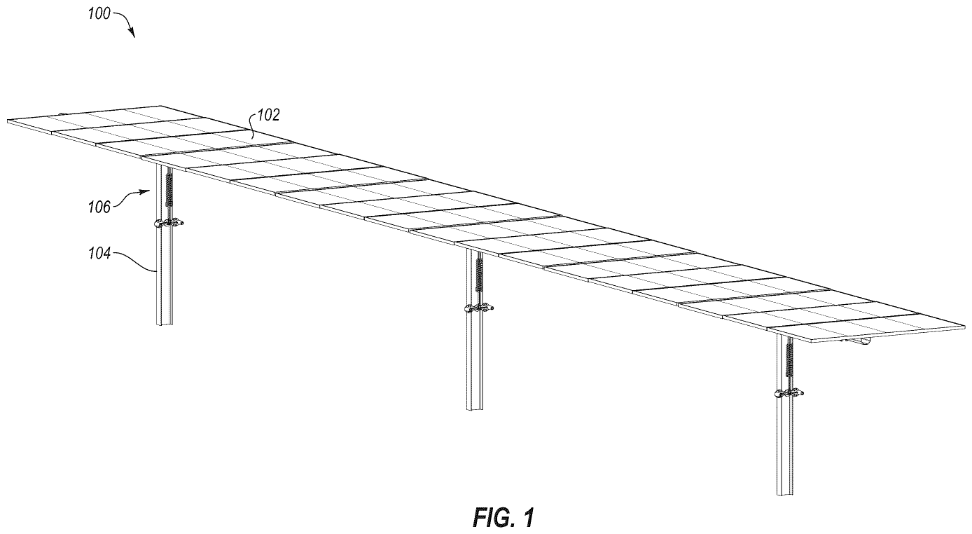

FIG. 1 illustrates an example photovoltaic (PV) system 100. The example PV system 100 may include PV modules 102, a support column 104, a counterbalance assembly 106, and a torque tube. The support column 104 may be driven into the ground and may provide vertical support for the torque tube and the PV modules 102. The torque tube may provide lateral support to the PV modules 102, and the torque tube may be rotated by a drive system including a motor (not shown). The PV modules 102 may be attached to the torque tube such that the rotation of the torque tube may be translated to the PV modules 102 enabling the PV modules 102 to track the position of the Sun in the sky throughout the day. For example, as the Sun rises and early in the day, the PV modules 102 may be rotated by the torque tube such that the PV modules 102 are facing an easterly direction, around mid-day the PV modules 102 may be horizontal or near horizontal, and, as the Sun sets and later in the day, the PV modules 102 may be rotated by the torque tube such that the PV modules 102 are facing a westerly direction.

The counterbalance assembly 106 may include a bottom bracket which may secure the counterbalance assembly 106 to the support column 104. The counterbalance assembly 106 may include a top bracket which may secure the counterbalance assembly 106 to the torque tube. The bottom bracket may be secured to the support column 104 at a distance below where the top bracket is secured to the torque tube.

The top bracket of the counterbalance assembly 106 may rotate with the torque tube about an axis of rotation between a first rotational limit in a first direction and a second rotational limit in a second direction. The rotational limits may be the maximum tilt angle of the example PV system 100 in each direction. In some embodiments, the axis of rotation may be the center of the torque tube. For example, the example PV system 100 may have a first rotational limit in a clockwise direction of rotation about the center of the torque tube and a second rotational limit in a counterclockwise direction of rotation about the center of the torque tube.

The counterbalance assembly 106 may also include a stretchable member. In some embodiments, the stretchable member may be a spring, an elastic cord, a belt, a strap, a tube, a coil, a cable, or any other stretchable member. In embodiments where the stretchable member is a spring, the stretchable member may be a linear spring or a variable-rate spring like a digressive or a progressive spring. In these and other embodiments, the stretchable member may be a compression spring or a tension spring.

The stretchable member may include a top end that is connected to the top bracket at a first connection point and a bottom end that is connected to the bottom bracket at a second connection point. The stretchable member may have an unstretched length that is different than a distance between the first and second connection points at zero degrees of torque tube rotation (e.g. at the starting position, equilibrium, balance, or zero degrees of tilt angle). Thus, connecting the top end of the stretchable member to the first connection point on the top bracket and the bottom end of the stretchable member to the second connection point on the bottom bracket may result in the stretchable member being pre-loaded with a force. The stretchable member may apply a restorative force to the torque tube as the torque tube rotates between the first and second rotational limits. For example, the stretchable member may be a compression spring and, as the torque tube rotates clockwise, the spring may be compressed, and the spring may apply a moment force to the torque tube in a counterclockwise direction such that the torque tube is influenced to rotate in the counterclockwise direction.

Generally, unless a pre-load is applied to the stretchable member, the restorative force will be negligible at low tilt angles. At low tilt angles, the force of the stretchable member is close to in-line or parallel to the lever arm extending between the first connection point and the axis of rotation such that the magnitude of the restorative force is zero or negligible. As a result, without a pre-load, there is little restorative force to counteract the overhanging weight of the PV modules 102 at low tilt angles. By utilizing a stretchable member with an unstretched length that is different than the distance between the connection points on the top and bottom brackets, the force exerted by the stretchable member is higher resulting in a higher restorative force at low tilt angles. This force may allow for better tilt control of the PV modules 102 at low tilt angles.

Furthermore, the stretchable member may allow for adjustability in the example PV system 100. For example, the unstretched length of the stretchable member may be selected based on the weight of the modules (e.g., depending on whether lightweight modules or heavyweight modules are used). The unstretched length of the stretchable member may be shorter in systems using heavyweight PV modules than the unstretched length of the stretchable member in systems using lightweight PV modules (thus a higher restorative force may be applied in the heavyweight PV module systems). Additionally or alternatively, the bottom bracket may be installed at different locations on the support column 104 thereby moving the second connection point. In response to the bottom bracket being moved closer to the top bracket (moving the first and second connection points closer together), the load may decrease. In response to the bottom bracket being moved away from the top bracket (moving the first and second connection points further apart), the load may increase. Thus, the bottom bracket may be adjusted to adjust the amount of load that the stretchable member experiences when the stretchable member is connected to the top bracket and the bottom bracket.

Modifications, additions, or omissions may be made to the example PV system 100 without departing from the scope of the present disclosure. For example, multiple PV modules 102, multiple support columns 104, and/or multiple counterbalance assemblies 106 may be used in the example system. As shown in FIG. 1, the counterbalance assembly 106 is used on every support column 104; however, in some embodiments, the counterbalance assembly 106 may not be used on every support column 104. For example, the counterbalance assembly 106 may be used on every other support column 104, or every third support column 104, at any other interval, or at any other spacing in the example PV system 100.

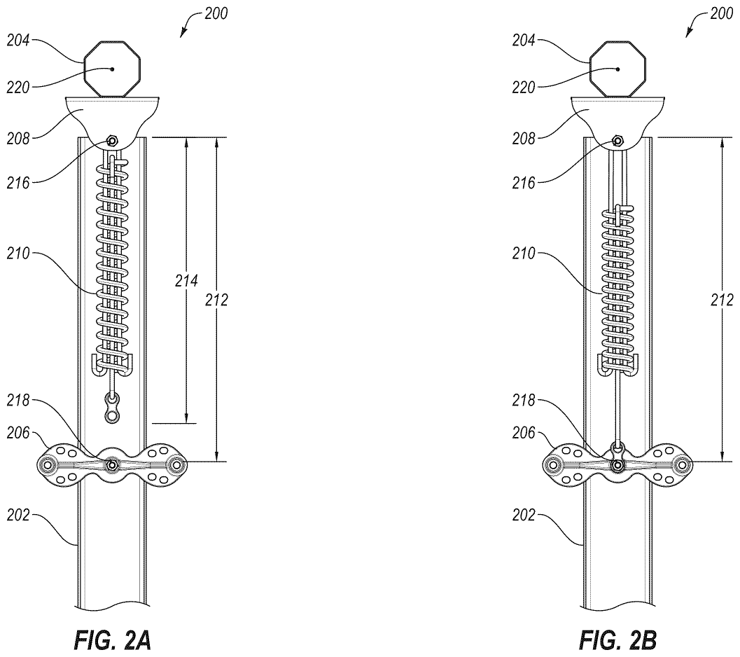

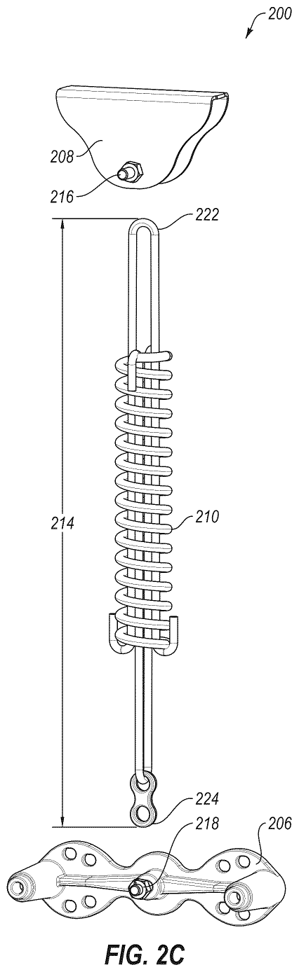

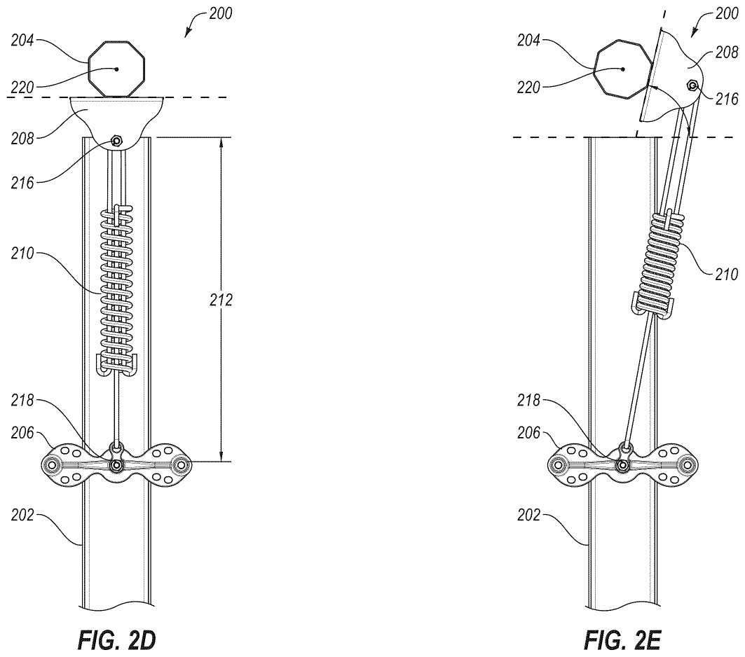

FIG. 2A illustrates a front-view of an example counterbalance assembly 200 including a stretchable member 210 that is in an unstretched state and is not connected to a bottom bracket 206. FIG. 2B illustrates a front-view of the example counterbalance assembly 200 where the stretchable member 210 is in a stretched state and is connected to the bottom bracket 206. FIG. 2C illustrates an exploded view of the counterbalance assembly 200. The counterbalance assembly 200 includes the bottom bracket 206, a top bracket 208, and a stretchable member 210.

The counterbalance assembly 200 may be secured to a torque tube 204 via the top bracket 208, and the top bracket 208 may rotate with the torque tube 204 about an axis of rotation 220. The axis of rotation 220 may be the center of the torque tube 204. The counterbalance assembly 200 may be secured to a support column 202 via the bottom bracket 206. The top bracket 208 may include a first connection point 216 and the bottom bracket 206 may include a second connection point 218. The first connection point 216 may be a distance 212 away from the second connection point 218 at zero degrees of torque tube rotation. For example, the distance 212 may be the length between the first connection point 216 and the second connection point 218 when the torque tube 204 has not begun rotation as shown in FIGS. 2A, 2B, and 2D.

As illustrated in FIG. 2C, the stretchable member 210 includes a top end 222 that is connected to the top bracket 208 at the first connection point 216 and a bottom end 224 that is connected to the bottom bracket 206 at a second connection point 218. In some embodiments, the top end 222 and/or the bottom end 224 may correspond to a portion of a drawbar. For example, as illustrated in FIG. 2C, the top end 222 may correspond to an upper portion of a first drawbar. In some embodiments, the top end 222 and/or the bottom end 224 may correspond to a fastener coupling the stretchable member 210 to the first connection point 216 and/or a fastener coupling the stretchable member 210 to the second connection point 218. For example, as illustrated in FIG. 2C, the bottom end 224 may correspond to a fastener coupling the stretchable member 210 to the second connection point 218. In these and other embodiments, the fastener may include a clevis, threaded fastener (e.g., a bolt), a link plate, a rod, a dowel, a rivet, a pin, and/or other suitable fasteners.

The unstretched length 214 may be different than the distance 212 between the first connection point 216 and the second connection point 218 at zero degrees of torque tube rotation. As shown in FIGS. 2A-2E, the stretchable member 210 is a linear, compression spring; however, the stretchable member 210 may be a tension spring, any other type of spring (e.g. digressive variable-rate spring, progressive variable-rate spring), an elastic cord, a belt, a strap, a tube, a coil, a cable, or any other stretchable member.

As shown in FIG. 2A, the unstretched length 214 may be shorter than the distance 212 between the first connection point 216 and the second connection point 218 such that, when the top end 222 of the stretchable member 210 is connected to the top bracket 208 at the first connection point 216 and the bottom end 224 of the stretchable member 210 is connected to the bottom bracket 206 at the second connection point 218, the stretchable member 210 is stretched creating a pre-load or tensile force in the stretchable member 210 that may increase the restorative force applied by the stretchable member 210 at low tilt angles.

In some embodiments, the unstretched length 214 is between about 50 millimeters and about 1000 millimeters shorter than the distance 212 between the first connection point 216 and the second connection point 218. In some embodiments, the unstretched length 214 is between about 100 millimeters and about 800 millimeters shorter than the distance 212 between the first connection point 216 and the second connection point 218. In some embodiments, the unstretched length 214 is between about 200 millimeters and about 500 millimeters shorter than the distance 212 between the first connection point 216 and the second connection point 218.

The difference between the unstretched length 214 and the distance 212 the first connection point 216 and the second connection point 218 may be adjusted during installation depending on the load that is required by selecting a stretchable member 210 with a different unstretched length and/or changing the distance 212 between the first connection point 216 and the second connection point 218. For example, the counterbalance assembly 200 may be adjusted for a higher load requirement by utilizing a stretchable member 210 with a greater difference between the unstretched length 214 and the distance 212 such that the pre-load in the stretchable member 210 may be higher. Additionally or alternatively, the bottom bracket 206 may be adjusted downwards to move the second connection point 218 downwards, which may increase the distance 212 causing the pre-load in the stretchable member 210 to be higher. The counterbalance assembly 200 may be adjusted for a lower load requirement by utilizing a stretchable member 210 with a lesser difference between the unstretched length 214 and the distance 212 such that the pre-load in the stretchable member 210 will be lower. Additionally or alternatively, the bottom bracket 206 may be adjusted upwards to move the second connection point 218 upwards, which may decrease the distance 212 causing the pre-load in the stretchable member 210 to be lower.

In some embodiments, the stretchable member 210 may be pre-stretched to the distance 212 between the first connection point 216 and the second connection point 218 before the top end 222 of the stretchable member 210 is connected to the top bracket 208 at the first connection point 216 and before the bottom end 224 of the stretchable member 210 is connected to the bottom bracket 206 at the second connection point 218. For example, the stretchable member 210 may be pre-stretched to the distance 212 between the first connection point 216 and the second connection point 218 in a manufacturing facility before the stretchable member 210 is installed in a photovoltaic system. Pre-stretching the stretchable member 210 may increase the ease of assembling the counterbalance assembly 200 on-site and may make the installation of the stretchable member 210 safer because a load need not be applied on site. In some embodiments (not expressly illustrated), the stretchable member 210 may be held in a pre-stretched position by a pin, a drawbar, or a cable. For example, one or multiple loops of cable may be used to hold the spring in a pre-stretched position. In some embodiments, the pin, drawbar, or cable, may be removed after the stretchable member 210 has been installed. In some embodiments, the stretchable member 210 may be a tension spring and may be held in a pre-stretched position by a beam, a pipe, or a rod placed within the spring. In these and other embodiments, the top end 222 and the bottom end 224 of the stretchable member 210 may be closed to aid the beam, pipe, or rod in holding a minimum extension in the stretchable member 210.

As shown in FIG. 2B, the stretchable member 210 is connected to the top bracket 208 at the first connection point 216 and the bottom bracket 206 at the second connection point 218 resulting in a tensile force in the stretchable member 210 before the torque tube 204 begins to rotate. The stretchable member 210 is shown as a compression spring including drawbars such that the tension created by stretching the drawbars to connect the spring to the bottom bracket 206 is translated inward by the drawbars to the spring resulting in the spring being compressed, which is shown in FIG. 2B. A greater difference between the unstretched length 214 of the stretchable member 210 and the distance 212 may result in a greater load and vice versa.

FIGS. 2D and 2E illustrate the counterbalance assembly 200 in operation at varying tilt angles. FIG. 2D shows the counterbalance assembly 200 at a starting position where the torque tube 204 has not begun rotation in either direction. At the starting position, the stretchable member 210 may have a pre-load or tensile force applied because the stretchable member 210 has been stretched to connect the bottom end 224 of the stretchable member 210 to the bottom bracket 206 and the top end 222 of the stretchable member 210 to the top bracket 208. However, the restorative force or moment force created by the stretchable member 210 may be zero at the starting position because the pre-load acts parallel or in line with the axis of rotation 220 of the counterbalance assembly 200 (the center of the torque tube 204). Furthermore, the weight of the modules may be supported by the support column 202 and the torque tube 204 may not have begun rotation at this point.

FIG. 2E shows the counterbalance assembly 200 at a tilt angle where the torque tube 204 has begun rotation and moved away from the starting position. As the torque tube 204 rotates, the stretchable member 210 may apply a restorative force to the torque tube 204. As shown in FIGS. 2D-2E, the stretchable member 210 is a compression spring, which may compress as the torque tube 204 rotates, in turn applying an increasing restorative force to the torque tube 204. Because the stretchable member 210 is preloaded with a tensile force, the restorative force from the stretchable member 210 is higher at lower tilt angles than if the stretchable member 210 was not preloaded. The restorative force may be a moment force determined based on the magnitude of the force applied by the stretchable member 210 perpendicularly to the lever arm between the first connection point 216 and the axis of rotation 220. The preloading of the stretchable member 210 increases the magnitude of the force applied by the stretchable member 210 at low tilt angles, which in turn, increases the restorative force applied by the stretchable member 210 and influences the PV module to return to the starting position.

Modifications, additions, or omissions may be made to the example counterbalance assembly 200 without departing from the scope of the present disclosure. For example, while a compression spring is shown in FIGS. 2A-2E, a tension spring, any other type of spring (e.g. digressive variable-rate spring, progressive variable-rate spring), an elastic cord, a belt, a strap, a tube, a coil, a cable, or the like may be used.

Furthermore, while the bottom end 224 is shown as corresponding to a fastener configured to couple the stretchable member 210 to the second connection point 218, it will be appreciated that the fastener may be omitted or included in the bottom bracket 206.

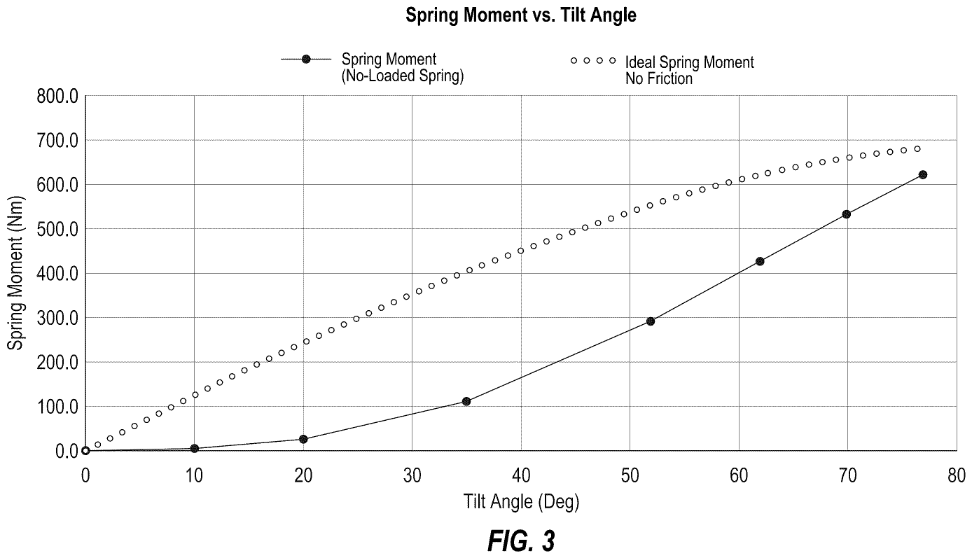

FIG. 3 is a chart showing the effect that a counterbalance assembly including a stretchable member that is not preloaded has on a restorative force. As shown in FIG. 3, the stretchable member may be a spring, and, upon rotation of the torque tube, the spring may create a restorative force that is a spring moment which influences the torque tube to return to a starting position thereby influencing the PV module to return to the starting position. The dotted line in FIG. 3 represents the ideal spring moment with no friction at varying tilt angles, and the solid line represents the spring moment at varying tilt angles where the spring is not preloaded. An “ideal spring moment” refers the moment experienced by the example spring illustrated in FIG. 3 with no friction such that the force exerted by the spring is substantially proportional to the distance that the spring is stretched or compressed.

As shown, the starting position is a tilt angle of 0 degrees. At zero degrees, the restorative force of the stretchable member may be 0 or negligent because the weight of the PV modules may be supported by the support column and the torque tube may not have begun rotation at this point.

As the torque tube rotates, the restorative force of the stretchable member may increase as the tilt angle increases. For example, the stretchable member may be a compression spring, and as the torque tube rotates and the tilt angle increases, the spring may be continually compressed resulting in a higher force as the tilt angle increases thereby creating a higher restorative force.

As shown in FIG. 3, the rotational threshold of the system may be around 78 degrees and at this point the spring moment or restorative force is at a maximum of around 620 N-m. Up until the maximum restorative force, the restorative force increases at an increasing rate of change. Because there is no preload applied to the stretchable member, the force at low tilt angles is negligible. For example, at 20 degrees, the spring moment is only about 20 N-m, which is roughly 3% of the maximum restorative force that is applied to the torque tube to influence the PV module to return to the starting position. As a result, at low tilt angles, the tilt control is reduced compared to the tilt angle at higher tilt angles, which is shown by the gap between the ideal spring moment curve and the actual spring moment curve in FIG. 3.

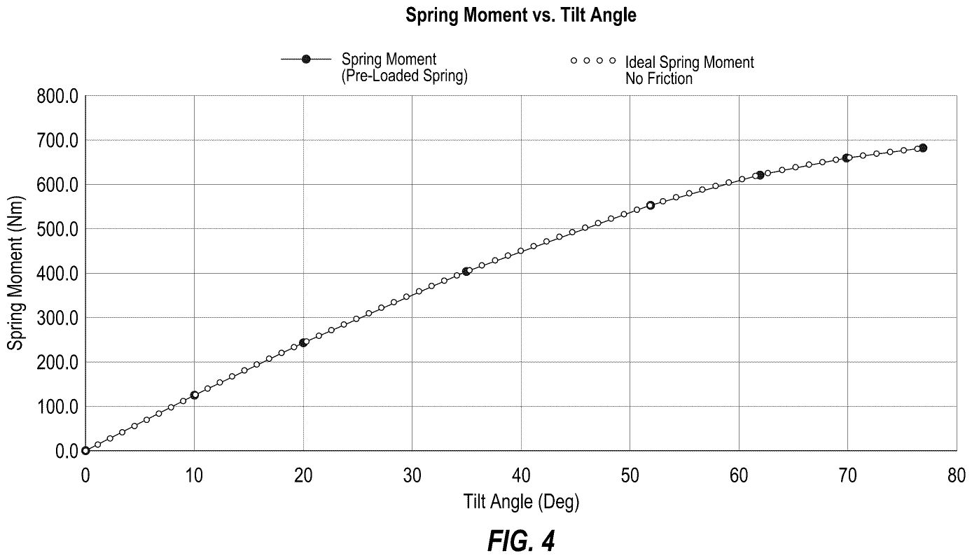

FIG. 4 is a chart showing the effect that the example counterbalance assembly 200 of FIGS. 2A-2E may have on the restorative force applied by the stretchable member 210 at varying tilt angles. As shown in FIG. 4, the stretchable member 210 may be a spring, and the spring may create a restorative force that is a spring moment which influences the torque tube 204 to return to a starting position thereby influencing the PV module to return to the starting position. The dotted line in FIG. 4 represents the ideal spring moment with no friction at varying tilt angles, and the solid line represents the spring moment where the spring is preloaded at varying tilt angles.

The stretchable member 210 may be preloaded with a force resulting from the stretchable member 210 being stretched to attach the bottom end 224 to the bottom bracket 206 at the second connection point 218 and the top end 222 to the top bracket 208 at the first connection point 216. However, at the starting position (e.g. equilibrium, balance, zero degrees of torque tube rotation, or zero degrees of tilt angle), the restorative force of the stretchable member 210 may be 0 or negligent because the force from the stretchable member 210 may be in line or parallel to the lever arm extending between the axis of rotation 220 of the counterbalance assembly 200 (the center of the torque tube 204) and the first connection point 216. Furthermore, the weight of the modules may be supported by the support column 202 and the torque tube 204 may not have begun rotation at this point.

As the torque tube 204 rotates in the first direction, the restorative force of the stretchable member 210 may increase as the tilt angle increases. As shown in FIG. 4, the rotational threshold may be around 78 degrees and, at the rotational threshold, the spring moment may reach a maximum of around 680 N-m. In contrast to FIG. 3, the restorative force at lower tilt angles is higher because the stretchable member 210 is preloaded with a force. For example, at a tilt angle of 20 degrees, the spring moment is around 250 N-m—roughly 12.5 times higher than the spring moment shown in FIG. 3 at 20 degrees where the spring is not preloaded and roughly 37% of the maximum spring moment (compared to 3% in FIG. 3). Also, in contrast to FIG. 3, the rate of change of the spring moment decreases at higher tilt angles. Hence, the counterbalance assembly 200 provides a more linear rate of change in the restorative force, and the restorative force applied by the counterbalance assembly 200 is closer to the ideal spring moment with no friction. Thus, the spring may provide for smoother and more controlled movement of the torque tube 204 as the PV module returns to the starting position.

Furthermore, the stretchable member 210 being preloaded allows for adjustability of the counterbalance assembly 200. For example, the ideal spring moment may change where different modules are used (e.g. heavyweight vs. lightweight). For these and other circumstances, the stretchable member 210 may be adjusted to provide more or less load depending on the restorative force requirements of the photovoltaic system by adjusting the distance 212 between the first connection point 216 and the second connection point 218 and/or selecting a stretchable member with a shorter or longer unstretched length 214.

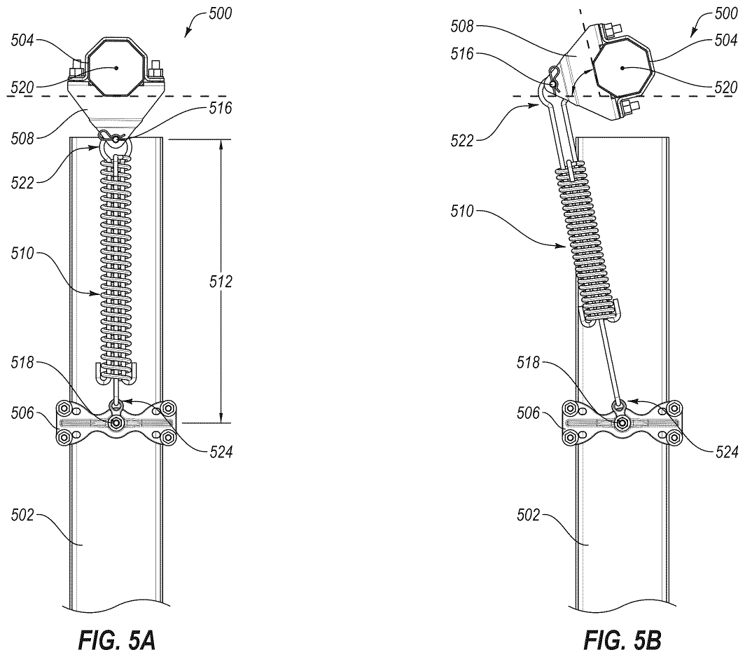

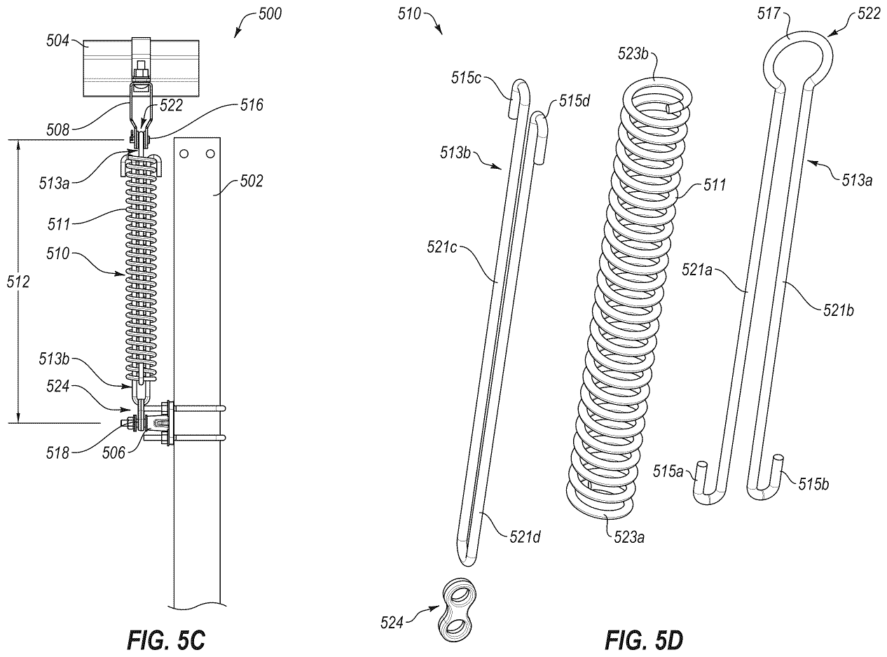

FIGS. 5A-5B illustrate another example counterbalance assembly 500 at varying tilt angles. The counterbalance assembly 500 may include similar components as the counterbalance assembly 200, which may function similarly to the components described in FIGS. 2A-2E. For example, the counterbalance assembly 500 may include a bottom bracket 506, a top bracket 508, and a stretchable member 510 that may be respectively similar to the bottom bracket 206, the top bracket 208, and the stretchable member 210 described with respect to FIGS. 2A-2E.

The counterbalance assembly 500 may be secured to a torque tube 504 via the top bracket 508, and the top bracket 508 may rotate with the torque tube 504 about an axis of rotation 520, as illustrated in FIG. 5B. The axis of rotation 520 may be the center of the torque tube 504.

The counterbalance assembly 500 may be secured to a support column 502 via the bottom bracket 506. The top bracket 508 may include a first connection point 516 and the bottom bracket 506 may include a second connection point 518. The first connection point 516 may be a distance 512 away from the second connection point 518 at zero degrees of torque tube rotation. For example, the distance 512 may be the length between the first connection point 516 and the second connection point 518 when the torque tube 504 has not begun rotation as shown in FIG. 5A.

The stretchable member 510 may be similar to and perform similar functions as the stretchable member 210. For example, as illustrated in FIG. 5A, the stretchable member 510 may include a top end 522 configured to be connected to the top bracket 508 at the first connection point 516 and a bottom end 524 configured to be connected to the bottom bracket 506 at a second connection point 518. In these and other embodiments, the unstretched length of the stretchable member 510 may be different than the distance 512 between the first connection point 516 and the second connection point 518 at zero degrees of torque tube rotation. As shown in FIGS. 5A-5B, the stretchable member 510 is a linear, compression spring; however, the stretchable member 510 may be a tension spring, any other type of spring (e.g. digressive variable-rate spring, progressive variable-rate spring), an elastic cord, a belt, a strap, a tube, a coil, a cable, or any other stretchable member.

Because the unstretched length of the stretchable member 510 may be shorter than the distance 512 between the first connection point 516 and the second connection point 518, a force may be pre-loaded into the stretchable member 510 when the stretchable member 510 is connected to the top bracket 508 at the first connection point 516 and the bottom bracket 506 at the second connection point 518. The pre-loaded force in the stretchable member 510 may be adjusted as described throughout this disclosure such as, for example, by selecting a different stretchable member and/or adjusting the position of the bottom bracket 506, among other adjustments.

In some embodiments, and as discussed previously, the stretchable member 510 may be a spring. As described previously with respect to FIG. 2B, the spring may include one or more drawbars (e.g., a drawbar spring). For example, as illustrated in FIGS. 5C and 5D, the stretchable member 510 may be a spring including a first drawbar 513a and a second drawbar 513b.

In these and other embodiments, the first drawbar 513a may be coupled to the top bracket 508 at the first connection point 516 and/or the second drawbar 513b may be coupled to the bottom bracket 506 at the second connection point 518. In some embodiments, the first drawbar 513a may be coupled to the first connection point 516 via a fastener and/or the second drawbar 513b may be coupled to the second connection pint via a fastener. As illustrated in FIG. 5C, the first drawbar 513a and/or the second drawbar 513b may be at least partially disposed within a coiled portion 511 of the spring.

In these and other embodiments, the first drawbar 513a may include a first portion 517 that may be positioned outside of the coiled portion 511 of the spring toward the top bracket 508. In these and other embodiments, the first portion 517 may correspond to the top end 522 of the spring.

In some embodiments, the first portion 517 may be wider than the coiled portion 511 of the spring. For example, the first portion 517 may be wider than the outer diameter of the coiled portion 511 of the spring. In these and other embodiments, the first portion 517 may function as a retention mechanism such that the coiled portion 511 may not be released under load. In these and other embodiments, the first portion 517 may have a round shape (e.g., circular, ovular, bulbous, or other round shapes), a square shape, and/or any geometric or non-geometric shape that may function to retain the spring under load.

In these and other embodiments, the second drawbar 513b may be coupled to the second connection point 518 via a fastener. In some embodiments, and as illustrated in FIGS. 5A-5D, the fastener may correspond to the bottom end 524. In these and other embodiments, the fastener may include a clevis, threaded fastener (e.g., a bolt), a link plate, a rod, a dowel, a rivet, a pin, and/or other suitable fasteners. For example FIG. 5A-5D, illustrates that the fastener corresponding to the bottom end 524, may include a link-plate coupling the second drawbar 513b to the second connection point 518.

In these and other embodiments, the first drawbar 513a and/or the second drawbar 513b may include one or more hooks 515. For example, the first drawbar 513a may include a first hook 515a and/or a second hook 515b, and/or the second drawbar 513b may include a third hook 515c and/or a fourth hook 515d.

In these and other embodiments, the drawbars 513 may include one or more shafts 521. For example, the first drawbar 513a may include a first shaft 521a and a second shaft 521b, and the second drawbar 513b may include a third shaft 521c and a fourth shaft 521d. In some embodiments, the shafts 521 may run through the interior of the coiled portion 511 of the spring. In some embodiments, the first portion 517 may extend between the first shaft 521a and the second shaft 521b. In some embodiments, a second portion may extend between the third shaft 521c and the fourth shaft 521d, which may be similarly or differently shaped than the first portion 517. For example, as illustrated in FIG. 5D, the second portion may be u-shaped and extend between the third-shaft 521c and the fourth shaft 521d.

In some embodiments, each hook 515 may extend from a respective shaft 521. For example, the first hook 515a may extend from the first shaft 521a, the second hook 515b may extend from the second shaft 521b, the third hook 515c may extend from the third shaft 521c, and the fourth hook 515d may extend from the fourth shaft 521d.

In these and other embodiments, the hooks 515 may contact an end of the coiled portion 511 of the spring. For example, the first drawbar 513a may run through the interior of the coiled portion 511 of the spring, and the first hook 515a and the second hook 515b may extend out and around a first end 523a (e.g., a lower end) of the coiled portion 511 of the spring. As another example, the second drawbar 514b may run through the interior of the coiled portion 511 of the spring, and the third hook 515c and/or the fourth hook 515d may extend out and around a second end 523b (e.g., an upper end) of the coiled portion 511 of the spring. The hooks 515 may be configured to retain the coiled portion 511 of the spring and/or to transfer load to the spring.

For example, because the unstretched length of the stretchable member 510 may be less than the distance 512, when the top end 522 is coupled to the top bracket 508 and the bottom end 524 is coupled to the bottom bracket 506, the hooks 515 may cause the spring to be pre-loaded with a force. For instance, the first hook 515a and the second hook 515b may transfer load to the first end 523a of the coiled portion 511 and the third hook 515c and the fourth hook 515d may transfer load to the second end 523b of the coiled portion 511, which may result in a load in the stretchable member 510 even at zero degrees of tilt.

In an example operation, FIG. 5A shows the counterbalance assembly 500 at a starting position where the torque tube 504 has not begun rotation in either direction. At the starting position, the stretchable member 510 may have a pre-load or force applied because the stretchable member 510 has been stretched to connect the bottom end 524 of the stretchable member 510 to the bottom bracket 506 and the top end 522 of the stretchable member 510 to the top bracket 508.

FIG. 5B shows the counterbalance assembly 500 at a tilt angle where the torque tube 504 has begun rotation and moved away from the starting position. As the torque tube 504 rotates, the stretchable member 510 may apply a restorative force to the torque tube 504. As shown in FIGS. 5A-5D, the stretchable member 510 is a compression spring, which may compress as the torque tube 504 rotates, in turn applying an increasing restorative force to the torque tube 504. For example, the hooks 526 may cause the spring to be compressed as illustrated in FIG. 5B.

Because the stretchable member 510 is preloaded with a force, the restorative force from the stretchable member 510 is higher at lower tilt angles than if the stretchable member 510 was not preloaded. The restorative force may be a moment force determined based on the magnitude of the force applied by the stretchable member 510 perpendicularly to the lever arm between the first connection point 516 and the axis of rotation 520. The preloading of the stretchable member 510 increases the magnitude of the force applied by the stretchable member 510 at low tilt angles, which in turn, increases the restorative force applied by the stretchable member 510 and influences the PV module to return to the starting position.

Modifications, additions, or omissions may be made to the example counterbalance assembly 500 without departing from the scope of the present disclosure. For example, while a compression spring is shown in FIGS. 5A and 5B, a tension spring, any other type of spring (e.g. digressive variable-rate spring, progressive variable-rate spring), an elastic cord, a belt, a strap, a tube, a coil, a cable, or the like may be used.

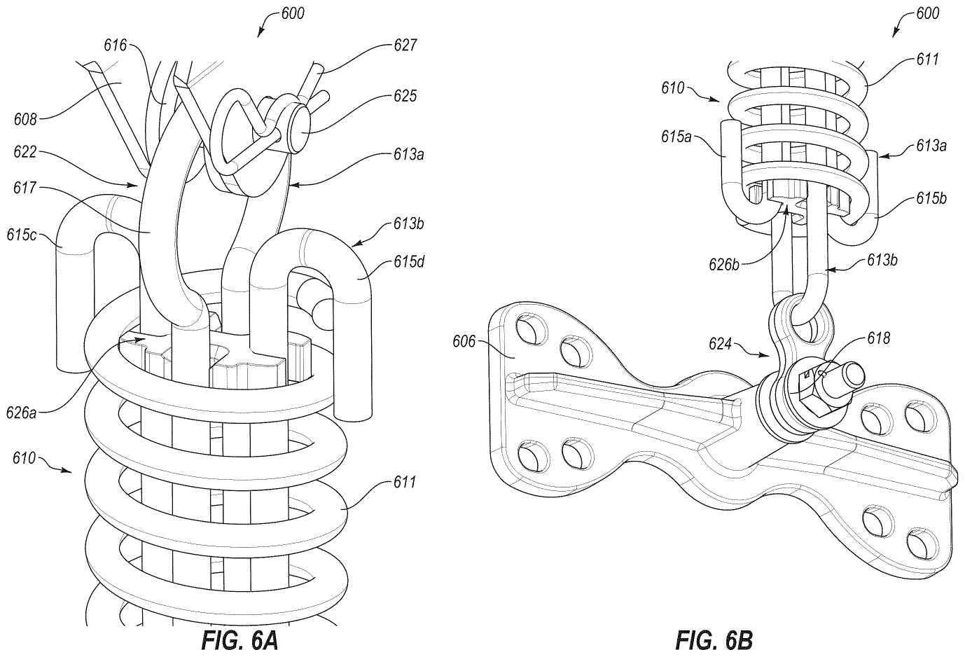

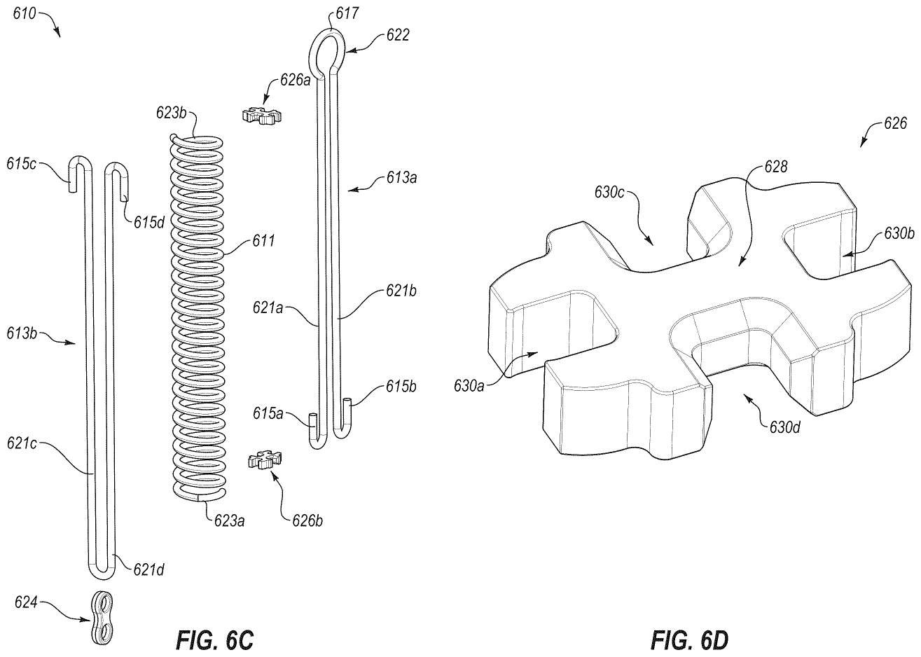

In some embodiments, one or more hooks 515 may be omitted. In some embodiments, the first portion 517 may not be wider than the coiled portion 511 such as shown with respect to FIGS. 2A-2E. In these and other embodiments, the drawbars 513 may be separated by a spacer such as the spacer 626 described with respect to FIGS. 6A-6C.

Furthermore, while the bottom end 524 is shown as corresponding to a fastener configured to couple the stretchable member 510 to the second connection point 518, it will be appreciated that the fastener may be omitted or included in the bottom bracket 506.

FIG. 6A is a partial view of a counterbalance assembly 600 illustrating a stretchable member 610 coupled to a top bracket 608, and FIG. 6B is another partial view of the counterbalance assembly of FIG. 6A illustrating the stretchable member 610 coupled to the bottom bracket 606. The top bracket 608, the bottom bracket 606, and the stretchable member 610 may be similar to those described throughout the present disclosure. For example, a top end 622 of the stretchable member 610 may be connected to the top bracket 608 at a first connection point 616 and a bottom end 624 of the stretchable member 610 may be coupled to the bottom bracket 606 at a second connection point 618.

As illustrated in FIGS. 6A and 6B, the stretchable member 610 may be a spring. In these and other embodiments, the spring may include a coiled portion 611, a first drawbar 613a, and a second drawbar 613b. In some embodiments, and as illustrated in FIGS. 6A and 6B the first drawbar 613a and the second drawbar 613b may be at least partially disposed within the coiled portion 611 of the spring. As illustrated in FIGS. 6A and 6B, the first drawbar 613a may be coupled to the top bracket 608 at the first connection point 616, and the second drawbar 613b may be coupled to the bottom bracket 606 at the second connection point 618. The first drawbar 613a and the second drawbar 613b may be similar to the drawbars 513 described with respect to FIGS. 5A-5D.

As illustrated in FIGS. 6A-6C, the first drawbar 613a may include a first hook 615a and/or a second hook 615b, and/or the second drawbar 613b may include a third hook 615c and/or a fourth hook 615d. As illustrated in FIG. 6C, each hook 615 may extend from a shaft 621 of a drawbar 613. For example, the first hook 615a may extend from a first shaft 621a of the first drawbar 613a, the second hook 615b may extend from a second shaft 621b of the first drawbar 613a, the third hook 614c may extend from a third shaft 621c of the second drawbar 613b, and the fourth hook 614d may extend from a fourth shaft 621d of the second drawbar 613b.

The first hook 615a and the second hook 615b may contact a first end 623a (e.g., a bottom end) of the coiled portion 611 of the spring. The third hook 615c and the fourth hook 615d may contact a second end 623b (e.g., an upper end) of the coiled portion 611 of the spring. In these and other embodiments, the first end 623a and the second end 623b may be opposite one another. The hooks 615 may be similar to the hooks 515 described with respect to FIGS. 5A-5D.

As illustrated in FIG. 6A, the first drawbar 613a may include a first portion 617 positioned outside of the coiled portion 611 of the spring toward the top bracket 608. In these and other embodiments, the first portion 617 may be wider than the coiled portion 611 of the spring. The first portion 617 may be similar to the first portion 517 described with respect to FIGS. 5A-5D.

In some embodiments, the first portion 617 of the spring may correspond to the top end 622 of the stretchable member 610. For example, the first portion 617 may be coupled to the top bracket 608 at the second connection point 618 via a first fastener 625. The first fastener 625 may be a threaded fastener (e.g., a bolt), a pin, a rod, a dowel, a rivet, a link plate, and/or other suitable fasteners that may couple the first portion 617 to the top bracket 608. In these and other embodiments, a secondary fastener 627 may be included that may retain the first fastener 625. For example, the secondary fastener 627 may be a nut, a pin (e.g., a cotter pin as illustrated in FIG. 6A), a wire, a clip, and/or other suitable secondary fasteners 627.

In some embodiments, the bottom end 624 may correspond to a fastener coupling the second drawbar 613b to the bottom bracket 606. For example, the bottom end 624 may correspond to a threaded fastener (e.g., a bolt), a pin, a rod, a dowel, a rivet, a link plate (as illustrated in FIG. 6B), and/or other suitable fasteners that may couple the bottom end 624 to the bottom bracket 606.

In some embodiments, the counterbalance assembly 600 may further include one or more spacers 626. In these and other embodiments, the one or more spacers 626 may be positioned between the first drawbar 613a and the second drawbar 613b. In some embodiments, multiple spacers 626 may be included. For example, the counterbalance assembly 600 may include a first spacer 626a and a second spacer 626b.

In some embodiments, the first spacer 626a and/or the second spacer 626b may be disposed within the coiled portion 611 of the spring. For example, as illustrated in FIGS. 6A-6C, the first spacer 626a may be disposed at the second end 623b (e.g., the upper end) of the coiled portion 611 of the spring and the second spacer 626b may be disposed at the first end 623a (e.g., the lower end) of the coiled portion 611 of the spring.

In these and other embodiments, the spacers 626 may be configured to inhibit the drawbars 613 from contacting one another as the spring is loaded. For example, the spacers 626 may be configured to inhibit the shafts 621 of the drawbars 613 from contacting one another. This may reduce the friction between the drawbars 613, which may improve the overall efficiency of the spring.

As illustrated in FIG. 6D, the spacer 626 may include a body 628 and one or more recesses 630 in the body 628. The recesses 630 may be sized and configured to receive a portion of the drawbars 613. For example, the recesses 630 may be sized and configured to receive a shaft 621 of the drawbars. For example, the first recess 630a and the second recess 630b may be sized and configured to receive the first shaft 621a and the second shaft 621b of the first drawbar 613a, and the third recess 630c and the fourth recess 630d may be sized and configured to receive the third shaft 621c and the fourth shaft 621d of the second drawbar 613b.

Because the shafts 621 of the drawbars 613 may be disposed within the recesses 630, the shafts 621 may be inhibited from coming into contact with another shaft 621. As a result, friction in the spring during operation may be reduced.

Modifications, additions, or omissions may be made to the example counterbalance assembly 600 without departing from the scope of the present disclosure. For example, the spacers 626 may be omitted, a single spacer 626 may be included, and/or more than two spacers 626 may be included. In some embodiments, the spacers 626 may include a greater or fewer number of recesses 630 depending on the configuration. For instance, the third recess 630c and the fourth recess 630d may be omitted.

The various features illustrated in the drawings may be, but are not necessarily, drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Relative terms used in the present disclosure and especially in the appended claims (e.g., bodies of the appended claims) are generally intended as falling within manufacturing tolerances and/or within scope reasonably understood by a person of skill in the art. For example, if two components are identified as being the “same” size, there may be variations consistent with manufacturing variances. Terms describing “approximately,” “similar,” “substantially,” or other terms designating similarity may convey within ten percent of the comparative value. For example, two components that are approximately the same size would be understood to be of a size within ten percent of each other.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A counterbalance assembly in a photovoltaic (PV) tracking system, the counterbalance assembly comprising:
a top bracket including a first connection point, the top bracket configured to be secured to a torque tube such that the top bracket rotates with the torque tube about an axis of rotation;
a bottom bracket including a second connection point, the bottom bracket configured to be secured to a column supporting the torque tube; and
a stretchable member having a top end connected to the top bracket at the first connection point, a bottom end connected to the bottom bracket at the second connection point, and an unstretched length that is different than a distance between the first and second connection points at zero degrees of torque tube rotation.

2. The counterbalance assembly of claim 1, wherein the unstretched length is between about 50 millimeters and about 1000 millimeters shorter than the distance between the first and second connection points.

3. The counterbalance assembly of claim 1, wherein the unstretched length is between about 100 millimeters and about 800 millimeters shorter than the distance between the first and second connection points.

4. The counterbalance assembly of claim 1, wherein the unstretched length is between about 100 millimeters and about 600 millimeters shorter than the distance between the first and second connection points.

5. The counterbalance assembly of claim 1, wherein the unstretched length is between about 200 millimeters and about 500 millimeters shorter than the distance between the first and second connection points.

6. The counterbalance assembly of claim 1, wherein the stretchable member is a spring.

7. The counterbalance assembly of claim 6, wherein the spring is a compression spring.

8. The counterbalance assembly of claim 6, wherein the spring is a tension spring.

9. The counterbalance assembly of claim 6, wherein the stretchable member is a linear spring.

10. The counterbalance assembly of claim 6, wherein the stretchable member is a variable-rate spring.

11. The counterbalance assembly of claim 1, wherein the stretchable member is pre-stretched to the distance between the first and second connection points before the top end of the stretchable member is connected to the top bracket at the first connection point and before the bottom end is connected to the bottom bracket at the second connection point.

12. The counterbalance assembly of claim 11, wherein the stretchable member is held in a pre-stretched position by a pin.

13. The counterbalance assembly of claim 12, wherein the pin is removable.

14. The counterbalance assembly of claim 6, wherein the spring includes a first drawbar at least partially disposed within a coiled portion of the spring, and the first drawbar is coupled to the top bracket at the first connection point.

15. The counterbalance assembly of claim 14, wherein a first portion of the first drawbar is wider than the coiled portion of the spring, the first portion being positioned outside of the coiled portion of the spring toward the top bracket.

16. The counterbalance assembly of claim 14, wherein the spring includes a second drawbar at least partially disposed within a coiled portion of the spring and the second drawbar is coupled to the bottom bracket at the second connection point.

17. The counterbalance assembly of claim 16, wherein at least one of the first drawbar or the second drawbar includes one or more hooks, each hook contacting an end of the coiled portion of the spring.

18. The counterbalance assembly of claim 17, wherein the first drawbar includes a first hook that contacts a first end of the coiled portion and the second drawbar includes a second hook that contacts a second end of the coiled portion, the second end being opposite the first end.

19. The counterbalance assembly of claim 16, wherein a spacer is positioned between the first drawbar and the second drawbar.

20. A photovoltaic (PV) system comprising:
one or more PV modules;
a torque tube coupled to the one or more PV modules, the torque tube configured to rotate the one or more PV modules;
a column supporting the torque tube; and
a counterbalance assembly coupled to the column and the torque tube, the counterbalance assembly including:
a top bracket including a first connection point, the top bracket configured to be secured to the torque tube such that the top bracket rotates with the torque tube about an axis of rotation;
a bottom bracket including a second connection point, the bottom bracket secured to the column supporting the torque tube; and
a stretchable member having a top end connected to the top bracket at the first connection point, a bottom end connected to the bottom bracket at the second connection point, and an unstretched length that is different than a distance between the first and second connection points at zero degrees of torque tube rotation.
